(19) United States
(12) Patent Application Publication
(10) Pub. No.: US 2025/0235986 A1
(43) Pub. Date: Jul. 24, 2025

(54) Spring Powered Bar Clamp

(71) Applicant: Richard Ned Steinberger, Nobleboro, ME (US)

(72) Inventor: Richard Ned Steinberger, Nobleboro, ME (US)

(21) Appl. No.: 19/028,808

(22) Filed: Jan. 17, 2025

Related U.S. Application Data
(60) Provisional application No. 63/623,543, filed on Jan. 22, 2024.

(51) Int. Cl. B25B 5/06

(52) U.S. Cl. CPC B25B 5/068

(57) ABSTRACT

A spring powered bar clamp has a sliding jaw longitudinally movable along a longitudinally extending bar. The sliding jaw extends forward of the bar. A first handle is fixed to the bar and extends rearward. A second handle is attached pivotable relative to the bar and the first handle about a first axis positioned at a location forward of the bar. The clamp includes a non-sliding jaw attached to the second handle in a pivotable engagement about a second axis positioned forward of the first axis. A spring biases the upper handle and lower handle away from one another. Embodiments exist that utilize a torsion spring or a coil spring for biasing the handles away from each other. The clamp can be lockable in a pre-loaded position wherein the spring is compressed and the handles are prevented from separating, and then unlockable from the pre-loaded position to clamp a part.

### CROSS-REFERENCE TO RELATED APPLICATION

This application claims priority to U.S. Provisional Application No. 63/623,543, filed Jan. 22, 2024, for Spring Powered Bar clamp, the entire content of which is incorporated herein by reference.

### BACKGROUND

The disclosed embodiments relate to a clamping product for use in building and construction projects and matters. More particularly, the embodiments relate to a spring powered clamp with a bar and sliding foot that is operable in two different modes, and which imparts significantly greater clamping force in use than traditional bar clamps.

Bar clamps are used in construction, carpentry, fine woodworking and similar building industries for temporarily holding one or more building members to another object, typically for allowing a builder to make a more permanent connection between multiple building members or to take another building action. A traditional bar clamp includes a pair of spaced apart cross jaws extending from a longitudinal support bar. At least one of the cross jaws is slidable and lockable along the support bar to clamp building members with the other cross jaw. In the most standard configuration of a bar clamp, one of the cross jaws includes a screw threadedly extending through it to allow for the clamp to be further tightened to the workpiece and/or adjusted.

Bar clamps with different tightening mechanisms have been developed over time, including those that utilize a ratchet mechanism for tightening and pressure adjustment in place of a screw in one of the cross bars. This style of bar clamp offers improved speed, efficiency and clamping strength compared to bar clamps with screws.

Spring powered clamps also exist, which translate force from a spring (torsion or compression) to clamping pressure. Depending on spring size and device configuration, some spring powered clamps are capable of providing greater clamping pressure than many bar clamps. However, given the natural characteristics of springs, spring powered clamps are often challenging to adjust and either provide very high clamping pressure with low sensitivity (powered with a larger, stronger spring) or low pressure (powered with a smaller, weaker spring).

It would thus be useful to have a clamp that improves upon the drawbacks of known clamps. The disclosed embodiments of the adjustable spring powered bar clamp are sensitive enough to clamp a member as thin as a sheet of paper and robust enough to clamp a member several feet thick. In addition, the configuration of the sliding foot makes it possible to increase the clamping force of the spring by a factor of 6 or more.

### SUMMARY

In one embodiment, a spring powered bar clamp includes a longitudinally extending bar with a lower jaw and upper jaw. The lower jaw is longitudinally movable along the bar and extends forward to it. A lower handle is fixed to and extends rearward from the bar, and an upper handle extends rearward of the bar. The upper handle is pivotally attached to a rigid upper intermediate cross bar at a handle pivot position forward of the bar. The upper jaw is pivotably attached to the upper handle at a position forward of the handle pivot position. A spring biases the upper handle and lower handle away from one another.

In another embodiment, a spring powered bar clamp, comprises a longitudinally extending bar and a sliding jaw longitudinally movable along and extending forward from the bar. A first handle is fixed to and extends rearward from the bar, and a second handle is attached pivotable relative to the bar and the first handle about a first axis positioned forward of the bar. A non-sliding jaw is attached to the second handle in a pivotable engagement about a second axis positioned forward of the first axis. A spring biases the upper handle and lower handle away from one another. The first axis is closer to the second axis than to the bar.

In yet another embodiment, a method of clamping a part between an upper jaw and a lower jaw includes a first step of providing a clamp. The clamp has a longitudinally extending and a first jaw longitudinally movable along and extending forward from the bar, a first handle fixed to and extending rearward from the bar, a second handle extending rearward from the bar and being pivotable relative to the bar and to the first handle at a first pivot axis, a second jaw pivotably attached to the second handle at a position forward of first pivot axis, a spring biasing the first handle and second handle away from one another, and a locking mechanism for optionally locking the handles in a locked position relative to one another in a compressed state. A part is placed between the first jaw and second jaw. The first jaw is advanced longitudinally along the bar until the jaws are in close proximity to the part. The first handle and second handle are squeezed toward each other against the bias from the spring to an energy storing position, and then locked relative to each other in an energy storing position via the locking mechanism. In the energy storing position, the first handle and second handle are prevented from separating under bias from the spring and the first jaw and second jaw clamp the part with an initial power. The first handle and second handle are unlocked, whereupon the first handle and second handle separate under bias from the spring, causing the first jaw and second jaw to clamp the part.

### BRIEF DESCRIPTION OF THE DRAWINGS

FIG. 1 is a rear perspective view of a first embodiment of the disclosed spring powered bar clamp clamped to a workpiece;

FIG. 2 shows a representation of an exemplary torsion spring for use within the clamp of FIG. 1;

FIG. 3 shows a side view of the clamp of FIG. 1 clamped to a workpiece in a fully opened position;

FIG. 4 shows a side view of the clamp of FIG. 1 clamped to the workpiece in a fully closed position;

FIG. 5 is a partial cross sectional view showing the interior of the upper jaw of the clamp of FIG. 1;

FIG. 6 is a partial cross sectional view showing the interior of the upper jaw of the clamp of FIG. 1 pre-release position;

FIG. 7 is a partial cross sectional view showing the interior of the upper jaw of the clamp of FIG. 1 in a released position;

FIG. 8 is another side view of the clamp of FIG. 1 clamped to a workpiece;

FIG. 9 is a rear perspective view of another embodiment of the disclosed spring powered bar clamp clamped to a workpiece;

FIGS. 10A and 10B show a representation of an exemplary spring assembly for use within the clamp of FIG. 9;

FIG. 11 is a side view of the clamp of FIG. 9 clamped to a workpiece in a fully opened position;

FIG. 12 is a side view of the clamp of FIG. 12 clamped to the workpiece in a fully closed position;

FIG. 13 is a front perspective view of the clamp of FIG. 9 clamped to workpiece showing the latch lever in a raised position;

FIG. 14 a front perspective view of the clamp of FIG. 9 clamped to workpiece showing the latch lever in a compressed position;

FIG. 15 is a partial cross sectional view of the clamp of FIG. 9 in a pre-loaded position; and

FIG. 16 is a partial cross sectional view of the clamp of FIG. 9 in a released position.

### DETAILED DESCRIPTION

Among the benefits and improvements disclosed herein, other objects and advantages of the disclosed embodiments will become apparent from the following wherein like numerals represent like parts throughout the figures. Detailed embodiments of a spring powered bar clamp, are disclosed; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may. The phrases “in another embodiment” and “in some other embodiments” as used herein do not necessarily refer to a different embodiment, although it may. Thus, as described below, various embodiments may be readily combined without departing from the scope or spirit of the invention.

As used herein, “based on” is not exclusive and permits being based on additional factors not expressly described unless the applicable context clearly dictates otherwise.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

Unless the context dictates the contrary, all ranges set forth herein are inclusive of their endpoints and open-ended ranges include only commercially practical values. Similarly, all lists of values are inclusive of intermediate values unless the context indicates the contrary. The recitation of ranges of values herein is merely intended to serve as a shorthand method of referring individually to each separate value falling within the range. Thus, unless otherwise indicated herein, each individual value of a range is incorporated into the specification as if it were individually recited herein. The use of any and all examples, or exemplary language (e.g., “such as”) provided with respect to certain embodiments herein is intended merely to better illuminate the inventive subject matter and is not a limitation on the scope of the inventive subject matter otherwise described and claimed.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Herein, the term “close proximity” with respect to the jaws and the part(s) encompasses conditions wherein the jaws are close enough to the part(s) such that releasing the clamp from the pre-release position results in the jaws clamping the part(s) initiated by the bias force from the released spring. This necessarily includes conditions wherein one or both of the jaws are contacting the part(s), the jaws are trapping the part(s) between them, or one or both of the jaws are not touching the part(s) but the part(s) is/are within the range of travel between the jaws. Herein, the term “clamp” or “clampingly engage” with respect to the jaws and part(s) refers to a condition wherein the jaws exert a compressive force, clamping force, pinching force, or similar, on the part(s).

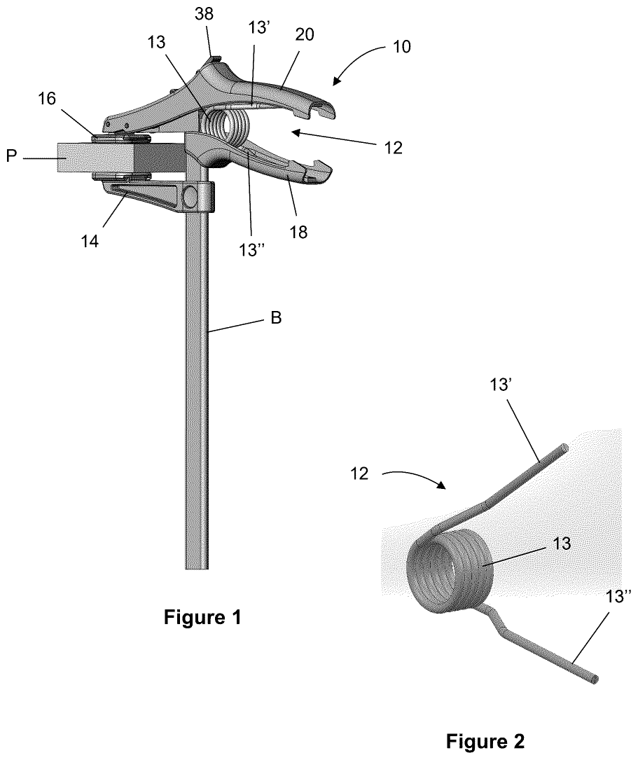

In a first embodiment shown in FIG. 1, a spring powered bar clamp 10 is powered by a torsion spring 12. The torsion spring 12 incorporates multiple, relatively large diameter coils 13 that are designed to deliver a power ratio of approximately 2:1 or less. A typical clamp torsion spring has a power ratio of 3:1 or above. The inventive disclosed embodiments allow a substantial reduction in power ratio by forming a relatively larger diameter coil and pre-tensioning it prior to incorporating it into the clamp. This results in a much smoother and reliable operation through the full range of clamping positions.

An exemplary torsion spring 12 for use within the clamp 10 is shown in isolation in FIG. 2, and includes a central large diameter coil 13 between a first (upper) leg 13′ and a second (lower) leg 13″. As shown in FIG. 1, the torsion spring 12 is positioned between the handles, 18 and 20, for transferring force thereto, resulting in a clamping force being applied on the opposing lower jaw 14 and upper jaw 16.

In this embodiment of the clamp 10, the clamping force increases as the clamping jaws, 14 and 16, are opened wider, and vice versa. Also in the depicted embodiment, the lower jaw 14 is longitudinally slidable along the bar B to accommodate workpieces or other parts of varying thicknesses. Opening of the jaws, 14 and 16, and handles, 18 and 20, is used to control the clamping force applied to the part(s) P being clamped. Each of the jaws, 14 and 16, may carry a respective resilient pad, 22 and 24, for contacting the part P without scuffing or damaging it and/or for improved friction. As shown in the Figures and discussed in further detail below, the upper jaw 16 is engaged with the upper handle 20 in a pivotable relationship via a pivot pin 23. While not depicted herein, embodiments of the clamp 10 exist wherein the lower jaw 14 includes pivotable features as well, such having a lower holding pad or structure pivotally attached to a rigid jaw portion.

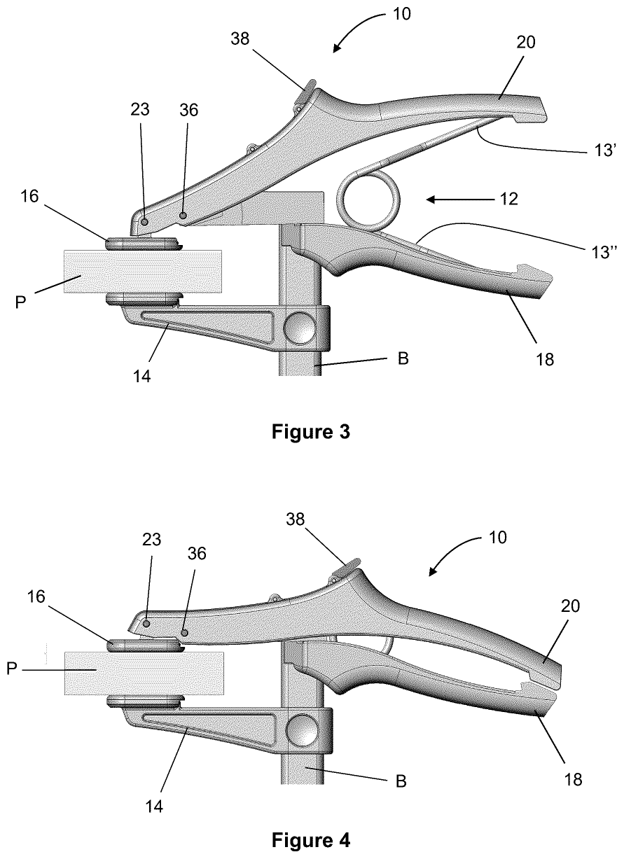

The handles, 18 and 20, are movable relative to one another between a fully open position, shown in FIG. 3, and fully closed position, shown in FIG. 4, with each position between the fully open and fully closed positions providing a different clamping power on the part P by the jaws, 14 and 16. The fully open position shown in FIG. 3 delivers approximately 33% of the clamping power as the fully closed position shown in FIG. 4.

Once the lower jaw 14 is moved to an operative position along the bar B, further adjustment of the position of the lower jaw 14 in relation to the upper jaw 16 via squeezing the handles, 18 and 20, together allows a user to control the clamping power applied to the part P. As will be discussed in detail below, the jaws, 14 and 16, are lockable relative to each other in numerous intermediate positions between the fully open position of FIG. 3 and fully closed position of FIG. 4 via locking the handles, with each position coinciding with a different clamping power.

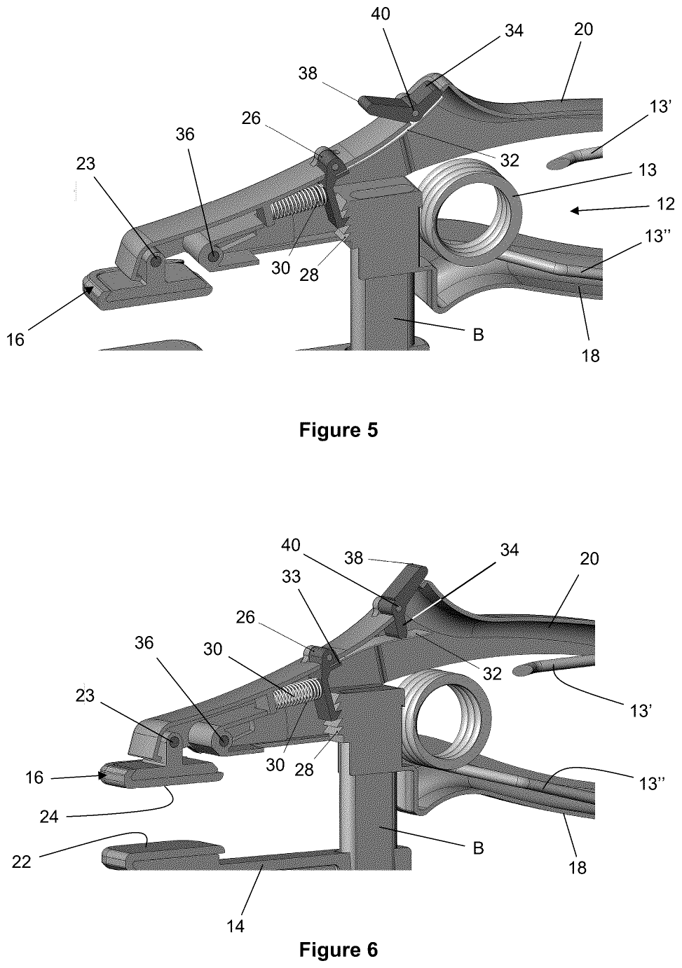

The clamp 10 includes a latch mechanism that allows a user to preload the torsion spring 12 at different power levels before using the clamp 10. In the embodiment depicted in FIGS. 1-8, the clamp 10 can be preloaded at five different positions via adjustment of the relative position of the handles, 18 and 20, each providing a different degree of power. As shown in FIGS. 5-7, this intermediate locking functionality is provided via an internal ratchet mechanism operable via a small lever 38 located forward of the upper handle 20 and bar B which is used to engage and disengage a pivotable latch hook 26 from ratchet teeth 28. FIG. 5 is a cross sectional view that shows a preferred embodiment of the herein described ratchet mechanism with the clamp handles, 18 and 20, locked via the latch hook 26 in place at a second of five ratchet teeth 28.

Key elements of the locking mechanism within the depicted embodiment of FIG. 5 include:
Latch lever: 38
Pivoting latch hook: 26
Ratchet teeth: 28
Latch spring (compression): 30
Release spring (leaf): 32

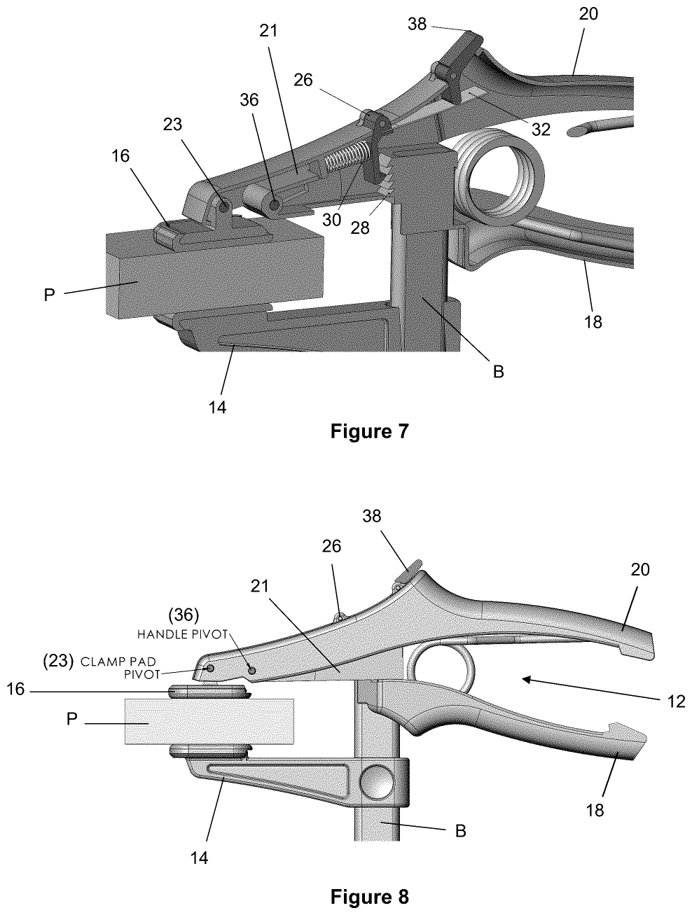

A pre-loaded mode of operating the clamp 10 will be described primarily with reference to FIGS. 6 and 7. FIG. 6 shows the clamp 10 in a pre-release position via the latch lever 38, which is rotatable about an axis defined by a retention pin 40, and carries a lower leg 34 extending obliquely therefrom. In this position, the latch lever 38 is rotated such that the lower leg 34 is reciprocated downward, which thereby presses down on the release spring 32. In this embodiment, the release spring 32 takes the form of a leaf spring extended from a rear end proximate the lower leg 34 to a front end 33 engaged with the latch hook 26. Pivoting the latch lever 38 rearward (clockwise in this view) and lower leg 34 downward to the pre-release position in this manner causes the latch hook 26 to pivot (also clockwise in this view) slightly against the bias of the compression spring 30. In this pre-release position, the latch hook 26 remains in place only via frictional engagement with the surface of the ratchet tooth 28.

When the ratchet mechanism is in the pre-release position shown in FIG. 6, a user can manually slide the lower jaw 14 toward the upper jaw 16 until the jaws contact the part P and/or are in close proximity to the part P. Thereafter, from the pre-release position, squeezing the handles together momentarily overcomes the friction between the respective ratchet tooth 28 and the latch hook 26 so that the latch hook swings into the open position and releases the spring force built up within the compresses torsion spring 12 and clamps the part with substantial power. This is shown in FIG. 7.

As can be seen in FIGS. 6 and 7, the upper handle 20 is pivotable relative to the lower handle 18 about a pin 36 that is forward of the bar B via an intermediate stationary cross bar 21, and relatively closer to the axis 23 about which the upper jaw 16 pivots. The rotational axis of the upper handle 20 defined by the pin 36 is approximately 0.75 inches from the rotational axis 23 of the upper jaw 16 in this embodiment. This distance controls clamping power and the range of movement of the jaws. Power increases and jaw range of movement decreases as the respective axes get closer, in direct proportion. Leveraging the jaw at this position distinguishes from known clamps of comparable configurations within which the handle(s) usually pivot coaxial to the torsion spring coil. In the depicted embodiment of the clamp 10, the lower handle 18 is fixed in position on an upper portion of the bar B with the lower jaw 14 slidable longitudinally along and pivotably fixed relative to the bar B. The upper handle 20 pivoting at this relatively forward location combined with the other described elements and relationships substantially increases the effective clamping power of the clamp 10. This configuration and operability is possible, in part, due to the lower sliding jaw 14 and pivot axis 36 of the upper handle 20 being positioned so that relatively little movement of the clamping pad is required to engage the part P. For example, the clamp shown in FIG. 8 has an opening range between the upper jaw 16 and lower jaw 14 of only approximately 0.25 inches. This geometry has been shown to deliver approximately 6× the clamping power as compared a spring-loaded clamp of the same approximate size with a jaw opening range of 1.5 inches.

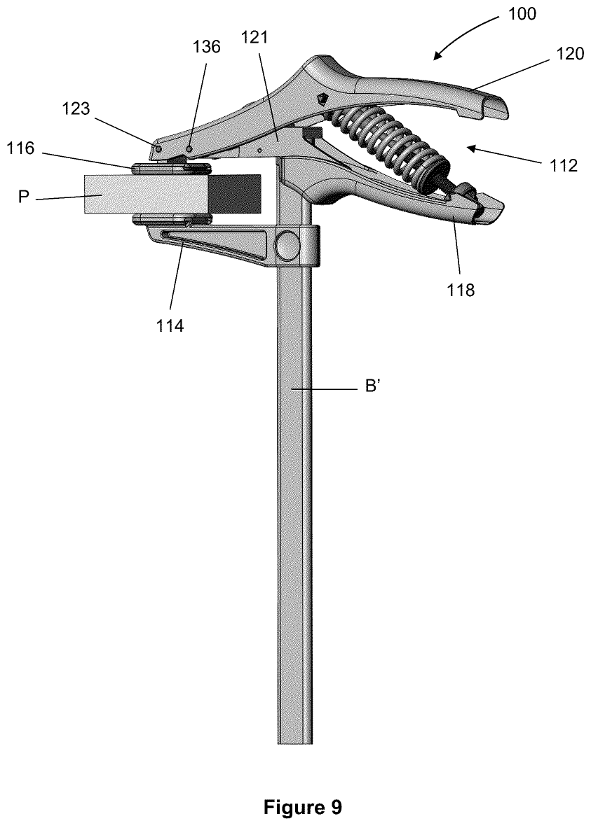

FIG. 9 depicts another embodiment of the spring powered bar clamp 100, powered by a compression spring module 112 instead of a torsion spring as in the embodiment of FIGS. 1-8. As will be described in detail below, the compression spring module 112 is pivoted at both ends, to the lower handle 118 and to the upper handle 120, such that the effective clamping force remains relatively constant throughout the entire range of movement of the jaws.

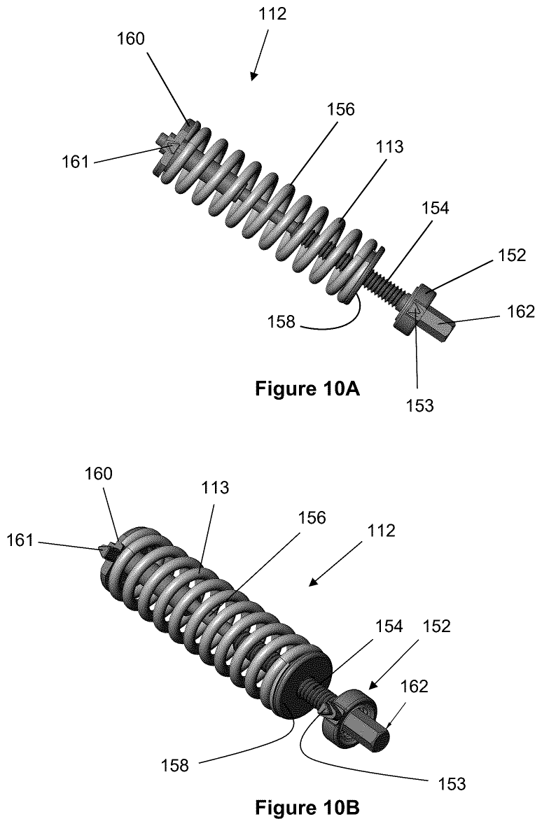

The spring module 112 is shown in FIG. 10 in isolation. The spring module 112 generally includes a relatively large diameter compression spring 113 and a central adjuster unit comprising a head 152, a post including a threaded segment 154 extending from the head to an unthreaded segment 156, adjustment plate 158, and end plate 160. The spring 113 is compressed between the adjustment plate 158 and the end plate 160 with the post extending through the center of the spring and defining the axis thereof. The power delivered to the clamp 100 is finely adjustable via rotating the head 152, which causes the adjustment plate 158 to travel along the threaded segment 154 to either increase or decrease compression of the spring 113. In this non-limiting embodiment, the head 152 includes pivot pins 153 for engaging the lower handle 114 and the end plate 160 includes parallel pivot pins 161 for engaging the upper handle 116. This arrangement permits the spring assembly 112 to pivot equally relative to each of the handles, 118 and 120, for maintaining relatively constant clamping power through the entire range of movement.

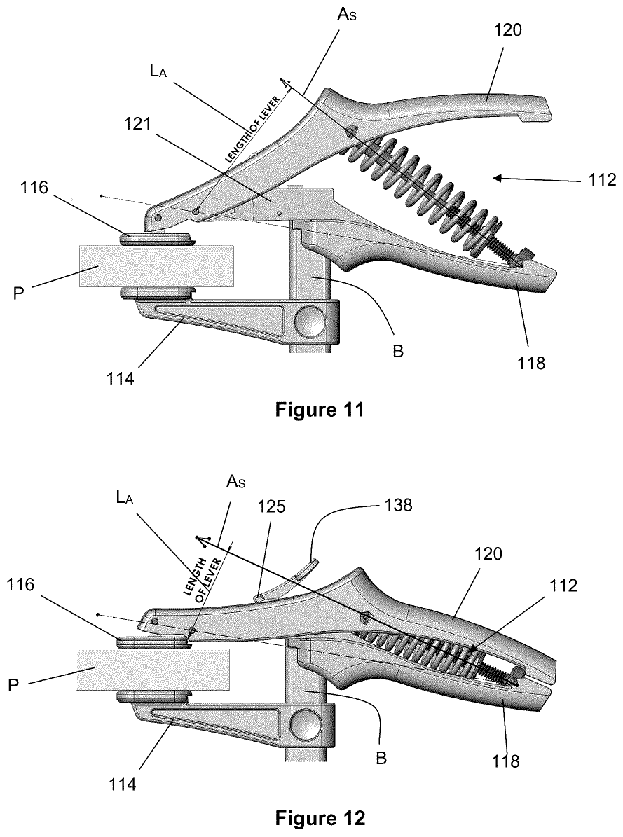

FIG. 11 depicts a fully opened position of the clamp 100 and FIG. 12 shows a fully closed position of the clamp 100, each defined by the relative position of the handles, 118 and 120. The power of the spring 113 increases as it is compressed between the handles, 118 and 120, which thereby reduces the length LA of a lever arm that transfers the spring force (torque) to the clamping jaws, 114 and 116. FIG. 11 shows the fully opened position of the handles (lower power) and FIG. 12 shows a fully closed position of the handles (higher power).

The effective clamping power of the spring 112 is further adjustable by rotating the head 152 and threaded segment 154 located at the central axis of the spring. The head 152 may include a hex drive 162 at its exposed rear end, which is used to adjust the position of the adjustment plate 158, and accordingly, the amount that the spring is compressed.

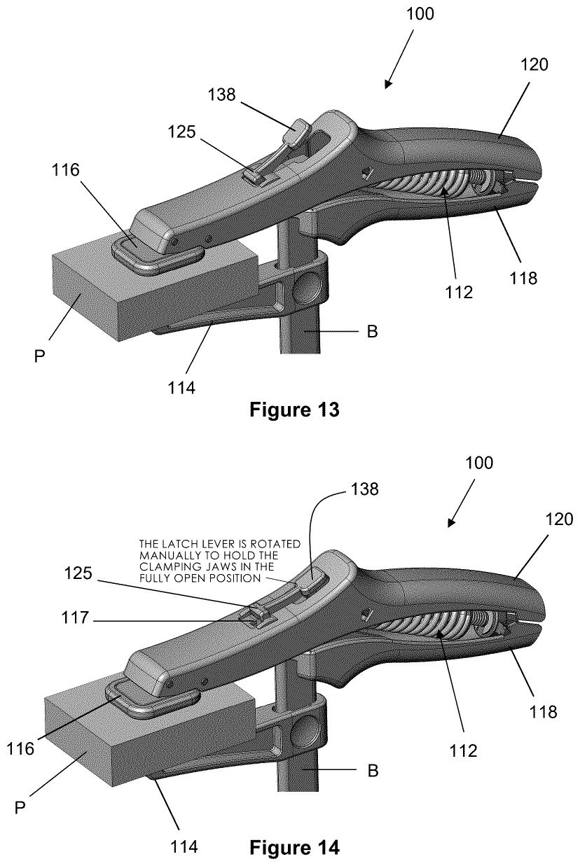

Like the earlier embodiment of the clamp 10 in FIGS. 1-8, the clamp 100 also includes a mechanism for pre-loading the spring assembly 112 via an operable latch 138. The latch 138 can be activated when the handles, 118 and 120, are fully squeezed together, as shown in FIGS. 13 and 14.

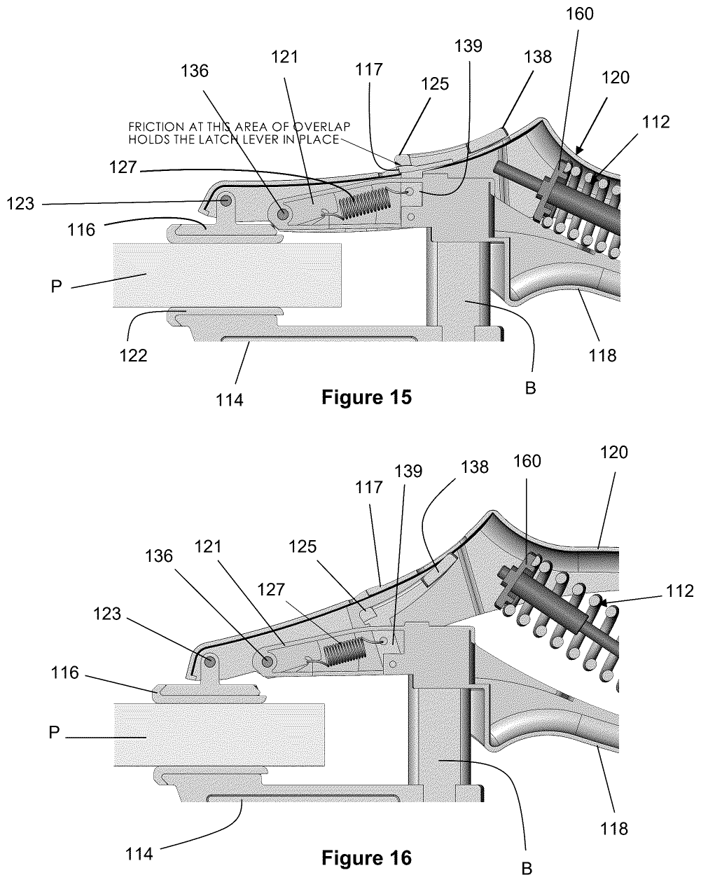

With reference to the cross sectional views of FIGS. 15 and 16, the latch 138 is biased forward (counterclockwise in the cross sectional views of FIGS. 15-16) by a coil spring 127 extended between a front portion of the latch 124 and the intermediate stationary cross bar 121. In this embodiment, the latch 138 has a modified L-shaped cross sectional shape with a lower leg of the “L” 139 extending into an interior portion of the clamp through an opening in the top surface of the upper handle 120. FIG. 13 shows the handles squeezed together (fully closed position) and the latch 124 in a disengaged, raised position. In this position, also depicted in FIG. 16, the coil spring 127 has pulled the latch 124 forward. From this position, the latch lever 124 can be pressed downward/rearward to rotate it clockwise into an engaged locked position shown in FIGS. 14 and 15. When the latch is engaged in this locked position, the handles, 118 and 120, are kept together in the closed position, which causes the clamping jaws, 114 and 116, to remain fully opened, as shown in FIG. 14.

Operation of the latch and locking mechanism can be best understood with reference to the partial cross sectional views of FIGS. 15-16. A user first traps a part P between the jaws, 114 and 116, by sliding the lower jaw 114 upward along the bar B, closing the handles, 118 and 120, and then pressing the lever 124 downward, pivoting it rearward (clockwise in the views of the Figures). When the latch lever 124 is depressed in this manner, the nose 125 of the lever is pivoted rearward to overlap an abutment surface 117 on the top side of the upper handle 120. This positioning of the nose 125 mechanically prevents the upper handle 120 from moving back upward under bias from the spring assembly 112, which thereby prevents the jaws, 114 and 116, from closing. When the spring assembly 112 pushes up on the upper handle 120, friction at the area of overlap between the nose 125 and abutment surface 117 keeps the latch lever 124 securely in place and the jaws locked in this relative position. This is referred to as the pre-loaded position.

Similar to the first embodiment of the clamp 10, the clamp 100 is released from the pre-loaded position via a user squeezing the handles, 118 and 120, together momentarily. The squeezing action eliminates the frictional hold between the abutment surface 117 on the upper handle 120 and the latch lever nose 125, thereby allowing the release spring 127 to pull the lever forward (counterclockwise in the depicted views). This releases the upper handle 120 to move upward under bias from the compressed spring assembly 112, thereby clamping the jaws, 114 and 116, together with a substantial amount power. FIG. 16 depicts the released position, which clamps the part P securely. As in the earlier embodiment, the upper handle 120 is pivotably relative to the lower handle about an axis 136 through an intermediate stationary cross bar 121 that is forward of the spring assembly 112.

As can be seen with reference to the Figures, the disclosed embodiments of the clamp 10 and 100 share multiple key characteristics that contribute to the efficacy of the clamp. Most notably, each of the embodiments utilizes the same relative pivot points of the top handle (20, 120) and clamping jaw (16, 116). Thus, each of the embodiments achieves substantially the same 6-to-1 power ratio as compared to a conventional spring clamp of the same type and size. The increased power ratio is provided by the reduction in jaw opening range from approximately 1.5 inches in known clamps to approximately 0.25 inches in the inventive clamp. Additionally, each of the embodiments of the clamp 10, 100 is operable in both (a) a standard clamping mode simply by squeezing and releasing the handles with a part loaded between the jaws, and (b) a pre-loaded-to-release mode for applying an increased clamping force, as described above.

The disclosed embodiments are described herein with reference to clamping “a part.” However, using and depicting a part in its singular form is merely for ease, efficiency and clarity of explaining the inventive concepts of the clamp. It is understood that the embodiments of the clamp are effective for clamping any number and type of parts, and indeed, are more often used to clamp multiple parts together. Further, two distinct configurations of locking mechanisms are specifically disclosed. The inventive concepts embodied in the spring powered bar clamp are not limited as such. Essentially, any mechanical locking mechanism can be employed provided that it is releasable from its locked position while the handles are closed against the spring bias.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A spring powered bar clamp, comprising:
a longitudinally extending bar;
a lower jaw longitudinally movable along and extending forward from the bar;
a lower handle fixed to and extending rearward from the bar;
a rigid upper intermediate cross bar attached to and extending forward from the bar;
an upper handle pivotably attached to the intermediate cross bar at a handle pivot position forward of the bar;
an upper jaw pivotably attached to the upper handle at a position forward of the handle pivot position; and
a spring biasing the upper handle and lower handle away from one another.

2. The spring powered bar clamp of claim 1, comprising a locking mechanism for optionally locking the handles in a locked position relative to one another in a compressed state, whereby biasing force from the spring does not force the respective handles to separate, wherein releasing the handles from the locked position to an unlocked position allows separation of the handles under the biasing force of the spring.

3. The spring powered bar clamp of claim 2, wherein the spring is a torsion spring positioned between the handles with one leg biasing the upper handle and another leg biasing the lower handle.

4. The spring powered bar clamp of claim 2, wherein the locking mechanism comprises a ratchet unit, wherein a latch tooth is lockable to any one of a plurality of spaced apart ratchet teeth.

5. The spring powered bar clamp of claim 2, wherein the locking mechanism comprises a lever movable between a locked position abutting an outer surface on the upper handle or an outer surface on the lower handle for mechanically preventing the handles from separating and an unlocked position releasing the handles.

6. The spring powered bar clamp of claim 1, wherein the spring is a torsion spring positioned between the handles with one leg biasing the upper handle and another leg biasing the lower handle.

7. The spring powered bar clamp of claim 1, wherein the spring is a compression spring positioned and compressed between the upper handle and the lower handle.

8. The spring powered bar clamp of claim 2, wherein the spring is a compression spring positioned between the upper handle and the lower handle.

9. The spring powered bar clamp of claim 1, wherein the handle pivot position is closer to the axis about which the upper jaw pivots relative to the upper handle than it is to the bar.

10. A method of clamping a part between an upper jaw and a lower jaw, comprising:
(a) providing a clamp with
a longitudinally extending bar;
a first jaw longitudinally movable along and extending forward from the bar;
a first handle fixed to and extending rearward from the bar;
a second handle extending rearward from the bar and being pivotable relative to the bar and to the first handle at a first pivot axis;
a second jaw pivotably attached to the second handle at a position forward of first pivot axis;
a spring biasing the first handle and second handle away from one another; and
a locking mechanism for optionally locking the handles in a locked position relative to one another in a compressed state;
(b) placing a part between the first jaw and second jaw;
(c) squeezing the first handle and second handle toward each other against the bias from the spring to an energy storing position;
(d) locking the first handle and second handle relative to each other in the energy storing position via the locking mechanism, whereupon the first handle and second handle are prevented from separating under bias from the spring and the first jaw and second jaw clamping the part with an initial power;
(e) advancing the first jaw longitudinally along the bar until the first jaw and second jaw are in close proximity to the part; and
(f) unlocking the first handle and second handle, whereupon the first handle and second handle separate under bias from the spring, causing the first jaw and second jaw to clamp the part.

11. The method of claim 10, wherein the second handle is pivotable about an axis positioned forward of the bar.

12. The method of claim 10, wherein the spring is a torsion spring positioned between the handles with one leg biasing the upper handle and another leg biasing the lower handle.

13. The method of claim 10, wherein the spring is a compression spring positioned and compressed between the upper handle and the lower handle.

14. The method of claim 10, comprising steps of:
providing a second part;
placing the second part and the first part between the first jaw and the second jaw, wherein
the step of unlocking clamps the first part and second part between the first jaw and second jaw.

15. A spring powered bar clamp, comprising:
a longitudinally extending bar;
a sliding jaw longitudinally movable along and extending forward from the bar;
a first handle fixed to and extending rearward from the bar;
a second handle attached pivotable relative to the bar and the first handle about a first axis positioned forward of the bar;
a non-sliding jaw attached to the second handle in a pivotable engagement about a second axis positioned forward of the first axis; and
a spring biasing the upper handle and lower handle away from one another.

16. The clamp of claim 15, further comprising an intermediate cross bar rigidly connected to and extending forward from the longitudinally extending bar, wherein the second handle is pivotably attached to the intermediate cross bar about the first axis.

17. The clamp of claim 16, comprising a locking mechanism for optionally locking the handles in a locked position relative to one another in a compressed state, whereby biasing force from the spring does not force the respective handles to separate, wherein releasing the handles from the locked position to an unlocked position allows separation of the handles under the biasing force of the spring.

18. The clamp of claim 17, wherein the locking mechanism comprises a lever movable between a locked position abutting an outer surface on the upper handle or an outer surface on the lower handle for mechanically preventing the handles from separating and an unlocked position releasing the handles.

19. The spring powered bar clamp of claim 17, wherein the locking mechanism comprises a ratchet unit, wherein a latch tooth is lockable to any one of a plurality of spaced apart ratchet teeth.

20. The clamp of claim 15, wherein the first axis is closer to the second axis than to the bar.
